(19) United States
(12) Patent Application Publication
(10) Pub. No.: US 2010/0200378 A1
(43) Pub. Date: Aug. 12, 2010

(54) POWER CUT OFF SWITCH FOR AN EXERCISE APPARATUS

(76) Inventor: Loao Wang, Taiping (TW)

Correspondence Address: Loao Wang, 13F, No. 23, Jiun-Ho St., Beitun District, Taichung, 406, TW

(21) Appl. No.: 12/368,285

(22) Filed: Feb. 9, 2009

(51) Int. Cl. H01H 1/00

(52) U.S. Cl. 200/284

(57) ABSTRACT

A power cut off switch for an exercise apparatus including two power contact tongues stably received within a housing in cooperation with elastic elements. The power contact tongues have certain distance from each other. The housing includes a hollow positioning portion corresponding to a pin body and a sliding collar such that the sliding collar provided for establishing an electric connection and moved by the pin body is receivable within the housing in such a way that the sliding collar is slidable within the positioning portion without detachment from the housing. As a result, the sliding collar is moved toward the power contact tongues when the pin body is inserted into the positioning portion of the housing. In this way, the sliding collar is in contact of the power contact tongues to establish an electric connection. In moving the pin body in a reverse direction, the sliding collar is detached from the power contact tongues such that an expected disconnection safety is ensured.

### BACKGROUND OF THE INVENTION

1. Fields of the Invention

The invention relates to a power cut off switch for an exercise apparatus, and more particularly, to a power cut off switch whose conductive elements are constantly received inside for protecting them from damage, thereby prolonging the service life.

2. Description of the Related Art

Generally, most of the conventional power-driven exercise apparatuses are provided with an emergency cutout switch for an easy and rapid interruption of electric current in case of emergency such that the safety of the operator and people around the apparatus may be ensured.

The most common safety switch is constructed in the shape of a safety pin. The operation principle lies in that an electric connection and disconnection is established by inserting and removing the pin, respectively. In this way, an expected safety effect is achieved.

In view of the conventional design, the pin made of plastic material acts as an insulator. In brief, the power contacts are interconnected when the insulator is inserted, and they are disconnected from each other when it is removed. According to this structure, all of the power contacts are received within the housing. If the insulating pin is partially broken, the broken part will stay within the housing forever. As a result, the disconnection effect is not achieved even when the insulating pin is removed. Thus, the operation safety is no more ensured.

It is often heard that the operator is injured due to the failure of the normal disconnecting function with the conventional safety pin. In order to eliminate the above-mentioned drawbacks, the manufacturer has developed an improved structure in which an intermediate conductive body and a pin are combined in one piece. The intermediate conductive body will be simultaneously pulled out when the pin is removed. In this way, both of the power contacts within the housing won't be contacted with each other forever. As a result, the safety is further ensured.

In view of the long-term use, however, the intermediate conductive body is easily worn and deformed due to an improper storage when it is removed from the housing with the pin. Thus, the electric connection effect and the power supply stability can be seriously affected. In other words, another problem is created. Consequently, a further improvement is required.

### SUMMARY OF THE INVENTION

A primary object of the invention is to provide a power cut off switch for an exercise apparatus whose intermediate conductive body is constantly received within the housing. Moreover, the corresponding elements are properly coupled and positioned such that the damage of the intermediate conductive body is avoided. In addition, the expected disconnection function is ensured.

According to the invention, a power cut off switch for an exercise apparatus includes two power contact tongues stably received within a housing in cooperation with elastic elements. The power contact tongues have certain distance from each other. The housing includes a hollow positioning portion corresponding to a pin body and a sliding collar such that the sliding collar provided for establishing an electric connection and moved by the pin body is receivable within the housing in such a way that the sliding collar is slidable within the positioning portion without detachment from the housing. As a result, the sliding collar is moved toward the power contact tongues when the pin body is inserted into the positioning portion of the housing. In this way, the sliding collar is in contact of the power contact tongues to establish an electric connection. In moving the pin body in a reverse direction, the sliding collar is detached from the power contact tongues such that an expected disconnection safety is ensured.

### BRIEF DESCRIPTION OF THE DRAWINGS

The accomplishment of this and other objects of the invention will become apparent from the following description and its accompanying drawings of which:

FIG. 1 is a perspective view of a preferred embodiment of a power cut off switch in accordance with the invention;

FIG. 2 is a top view of the preferred embodiment of a power cut off switch according to FIG. 1;

FIG. 3 is a perspective view of partial components of the power cut off switch according to FIG. 1;

FIG. 4 is a top view of the structure according to FIG. 3;

FIG. 5 is a perspective view of the structure according to FIG. 3 wherein a first operation position is illustrated;

FIG. 6 is a top view of the structure according to FIG. 4 wherein a first operation position is illustrated;

FIG. 7 is a perspective view of the structure according to FIG. 1 wherein a second operation position is illustrated; and

FIG. 8 is a top view of the structure according to FIG. 4 wherein a second operation position is illustrated.

### DETAILED DESCRIPTION OF THE PREFERRED EMBODIMENT

The present invention will now be described in more detail hereinafter with reference to the accompanying drawings that show a preferred embodiment of the invention.

In order to achieve a better demonstration effect, the outer cover (not shown) of the housing 10 of the invention is removed to understand the basic arrangement of the internal components within the housing 10.

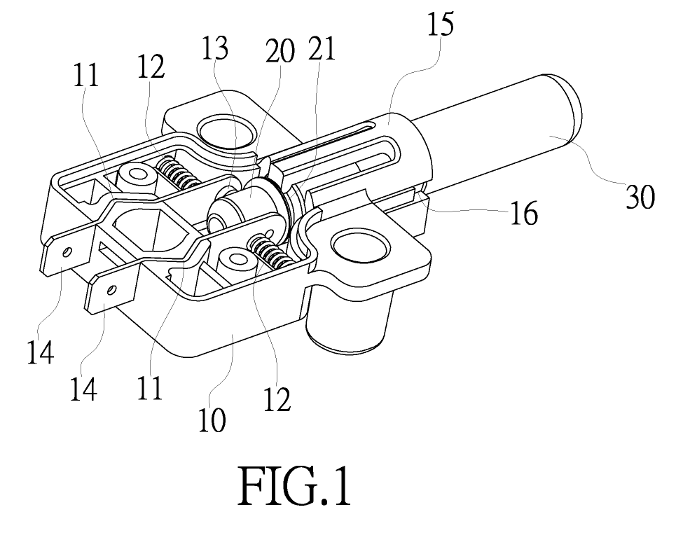

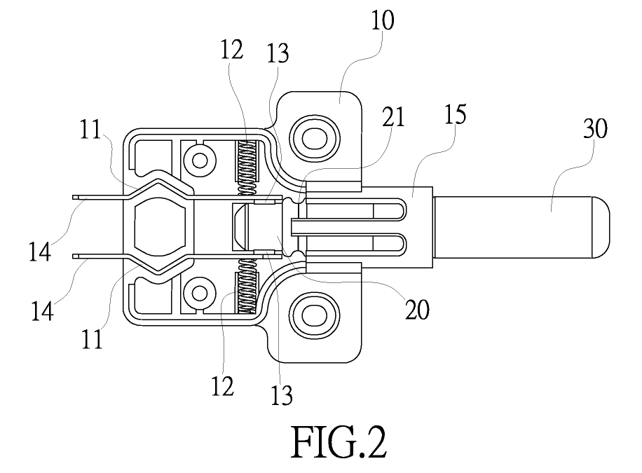

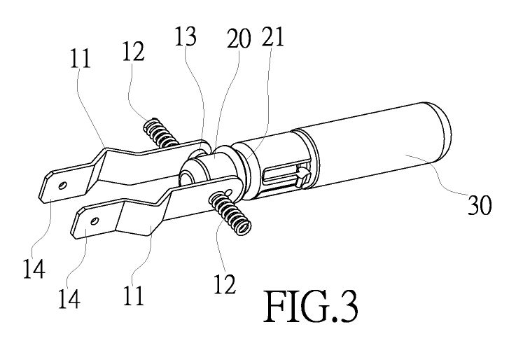

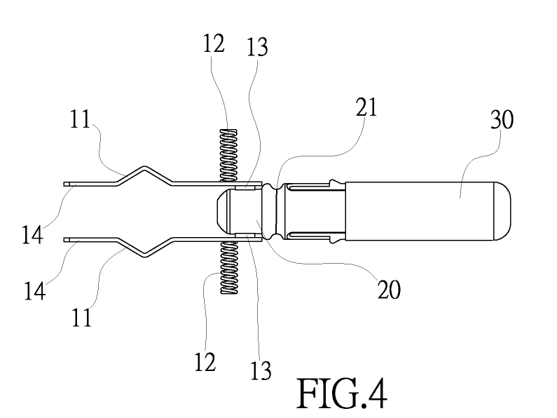

Referring to FIGS. 1 through 4, a power cut off switch for an exercise apparatus in accordance with a preferred embodiment of the invention includes a housing 10, a sliding collar 20, and a pin body 30.

The housing 10 includes two power contact tongues 11 and two elastic elements 12 constantly resting against the outer side of the power contact tongues 11. The power contact tongues 11 have certain distance from each other. Both of the power contact tongues 11 each include a conductive protrusion 13 at the internal side thereof. Moreover, the power contact tongues 11 each includes a free end 14 jutting out from the housing 10 for an electric connection. In addition, a hollow positioning portion 15 is provided at a place receiving the pin body 30 and the sliding collar 20.

The sliding collar 20 is made of conductive metal and received within the positioning portion 15 of the housing 10 in such a manner that a sliding connection without detachment from the housing 10 is created.

The pin body 30 acts as an isolator. The pin body 30 is insertable into or removable from the hollow positioning portion 15 of the housing 10 in such a manner that an electric connection or disconnection is established.

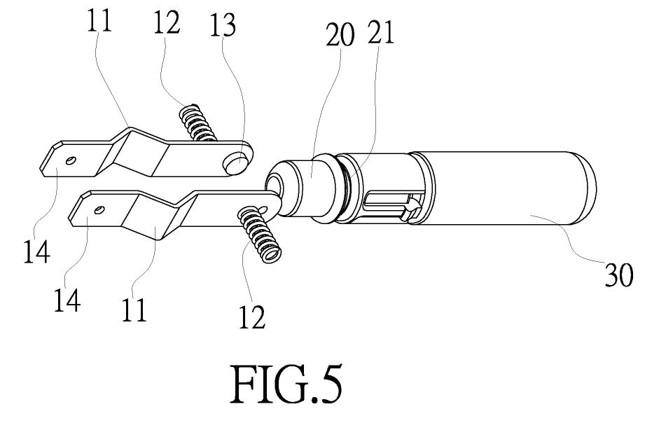

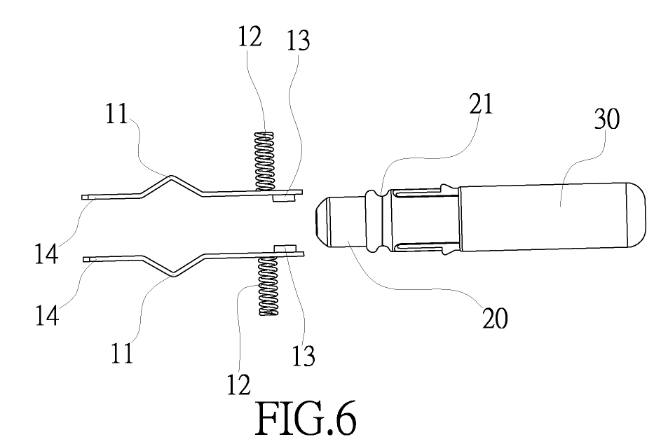

Based on the assembly of the above-mentioned components, the sliding collar 20 is moved toward the power contact tongues 11 when the pin body 30 is inserted into the positioning portion 15 of the housing 10. In this way, the sliding collar 20 is in contact of the conductive protrusions 13 to establish an electric connection. In moving the pin body 30 in a reverse direction, the sliding collar 20 is detached from the conductive protrusions 13 (see FIGS. 5 and 6) such that an expected disconnection safety is ensured.

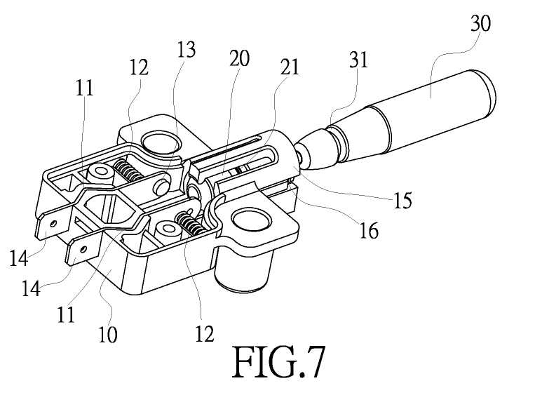

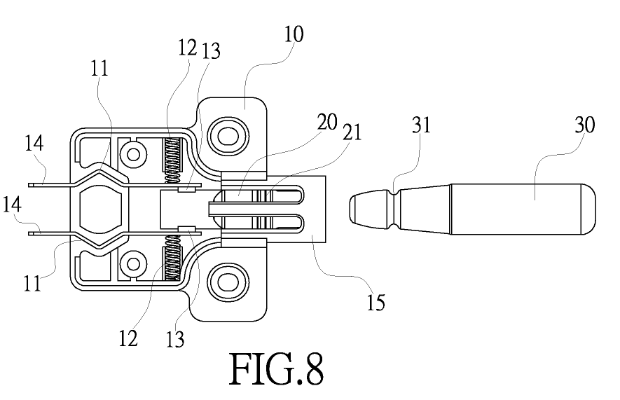

In order to achieve a reliable displacement of the sliding collar 20 moved by the pin body 30, the end of the pin body 30 includes an annular groove 31 corresponding to a locking portion 21 at the internal side of the sliding collar 20 (see FIGS. 7 and 8) such that the annular groove 31 and the locking portion 21 are engaged with each other in a coupled state. Besides, the housing 10 includes a barbed hook 16 at the internal rim near the free end of the positioning portion 15 for a reliable reception of the sliding collar 20 within the positioning portion 15 of the housing 10. In this way, the sliding collar 20 is detached from the pin body 30 in a forced way when the sliding collar 20 is moved to the barbed hook 16.

Based on the above-mentioned design, the drawbacks of the conventional product in design and use can be eliminated, thereby achieving a safe operation and a prolonged service life.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A power cut off switch for an exercise apparatus including two power contact tongues stably received within a housing in cooperation with elastic elements, the power contact tongues having certain distance from each other, the housing having a hollow positioning portion corresponding to a pin body and a sliding collar such that the sliding collar provided for establishing an electric connection and moved by the pin body is receivable within the housing in such a way that the sliding collar is slidable within the positioning portion without detachment from the housing,
wherein the sliding collar is moved toward the power contact tongues when the pin body is inserted into the positioning portion of the housing; therefore, the sliding collar is in contact of the power contact tongues to establish an electric connection; moreover, in moving the pin body in a reverse direction, the sliding collar is detached from the power contact tongues such that an expected disconnection safety is ensured.

2. A power cut off switch for an exercise apparatus, comprising a housing, a sliding collar, and a pin body,
wherein the housing includes two power contact tongues and two elastic elements constantly resting against the outer side of the power contact tongues, and the power contact tongues have certain distance from each other, and both of the power contact tongues each include a conductive protrusion at the internal side thereof, and the power contact tongues each have a free end jutting out from the housing, and a hollow positioning portion is provided at a place receiving the pin body and the sliding collar;
wherein the sliding collar is made of conductive metal and received within the positioning portion of the housing in such a manner that a sliding connection without detachment from the housing is created; and
wherein the pin body acts as an isolator, and the pin body is insertable into or removable from the hollow positioning portion of the housing in such a manner that an electric connection or disconnection is established.

3. The power cut off switch for an exercise apparatus as claimed in claim 2 wherein the end of the pin body includes an annular groove corresponding to a locking portion at the internal side of the sliding collar such that the annular groove and the locking portion are engaged with each other in a coupled state.

4. The power cut off switch for an exercise apparatus as claimed in claim 2 wherein the housing includes a barbed hook at the internal rim near the free end of the positioning portion.
